(19) United States
(12) Patent Application Publication
(10) Pub. No.: US 2011/0143088 A1
(43) Pub. Date: Jun. 16, 2011

(54) NIO NANOSHEET STRUCTURE POSSESSING THE (111) CRYSTALLOGRAPHIC PLANES WITH HEXAGONAL HOLES, METHOD FOR PREPARING THE SAME AND USES THEREOF

(75) Inventors: Ryan Richards, Golden, CO (US); Juncheng Hu, Wuhan (CN)

(73) Assignee: Jacobs University Bremen gGmbH, Bremen (DE)

(21) Appl. No.: 12/735,610

(22) PCT Filed: Mar. 10, 2008
(86) PCT No.: PCT/EP2008/001901

§ 371 Date: Dec. 9, 2010

(51) Int. Cl. C01G 53/04; B32B 3/24; B32B 9/00; B82Y 40/00; B82Y 30/00

(52) U.S. Cl. 428/135; 423/594.19; 428/220; 977/896; 977/755

(57) ABSTRACT

Method for preparing a NiO nanosheet structure possessing (111) crystallographic planes as a primary surface with hexagonal holes, comprising the following steps: a) preparing a methanol solution of a nickel salt selected from the group consisting of nickel nitrate, nickel sulphate, nickel chlorate, nickel acetate, and nickel phosphate or a mixture thereof; b) adding benzyl alcohol (BZ), optionally substituted with alkyl, nitro, halo or amino, or a mixture thereof and urea to the solution of (a) in a ratio of Ni to BZ or substituted BZ of at least 1; c) solvent removal and calcination in air of the mixture, plate-like NiO nanosheet precursors therefore, NiO nanosheet structures obtainable by that method as well as various novel uses thereof.

### FIELD OF THE INVENTION

The invention is related to a novel form of NiO possessing the (111) crystallographic planes as a primary surface, preferably as a so-called nanosheet structure, which contains hexagonal holes, as well as to a novel method of preparing the same, and various uses thereof. In particular, the invention is related to the template-free, halide-free, wet chemical route to synthesize the NiO nanosheets with hexagonal holes possessing the (111) lattice plane as the main surface from a nickel salt, preferably nickel nitrate, as a starting material.

### BACKGROUND ART

A major challenge in materials engineering is the controlled assembly of purposefully designed molecules or ensembles of molecules into meso-, micro-, and nanostructures to provide an increasingly precise control at molecular levels over structure, properties and function of materials (Michal, D. W. Nature 2000, 405, 293 and Dai. Z. F. et al., Adv. Mater. 2001, 13, 1339). The controlled synthesis and characterization of low dimensional crystalline objects is a major objective in modern materials science, physics and chemistry (J. Polleux, at al., Angew. Chem. Int. Ed., 2006, 45, 261 and Angew. Chem. 2005, 118, 267). Recently, one-dimensional nanostructures such as nanorods, nanowires and nanotubes have been intensively studied due to their novel properties and potential application as components and interconnects in nanodevices (Xia, Y. N. et al., Adv. Mater. 2003, 15, 353).

However, nanosheets with desired holes have not been widely studied due to a lack of the knowledge for their preparation. There are only two articles regarding the synthesis of platinum nanosheets containing hexagonal holes which used graphite as a template (Shirai, M. et al., Chem. Comm. 2000, 623; Shirai, M. et al., J. Phys. Chem. B 2001, 105, 7211), but there is no report on the synthesis of metal oxides nanosheets with hexagonal holes.

Moreover, hard template assisted processes may have shortcomings for practical application due to the high cost and time requirement (Yang, Z. Z. et al., Angew. Chem. Int. Ed. 2003, 42, 1943; Angew. Chem. 2003, 115, 1987).

Nickel oxide is a particularly interesting oxide because of its chemical and magnetic properties. There are numerous potential attractive applications in a variety of fields, such as catalysis, battery cathodes, gas sensors, electrochromic films, magnetic materials, active optical fibers and fuel cell electrodes (Makus, R. C. et al., J. Electrochem. Soc. 1994, 141, 3429; and Lunkenheimer, P. et al., Phys. Rev. B 1991, 44, 5927).

The traditional method for preparation of NiO is the thermal decomposition of either nickel salts or nickel hydroxides, which results in inhomogeneity of morphology, crystallite size and low surface area. Many efforts have been exerted to prepare NiO possessing controlled shapes and morphologies. Wire-like nickel was prepared by inserting nickel into carbon nanotubes using metal organic chemical vapour deposition of nickelocene (Matsui, K. et al., Chem. Commun. 1999, 1317). Monodisperse nanoparticles of Ni and NiO were synthesized employing the thermal decomposition of metal-surfactant complexes (Park, J. et al., Adv. Mater. 2005, 17, 429). Macroporous NiO and metallic Ni with 250-500 nm monodisperse voids were synthesized based on templated precipitation and subsequent chemical conversion of the precursors to macroporous metal or metal oxides (Yan, H. et al., Adv. Mater. 1999, 11, 1003). NiO hollow spheres have been synthesized by thermal decomposition of the as-synthesized Ni(OH)₂ hollow spheres (Wang, Y. et al., Chem. Commun. 2005, 5231). NiO and à-Ni(OH)₂ nanostructures mixture of nanosheets and nanorods were also synthesized by a NiC₂O₄ conversion method (Li X. et al., Nano Lett. 2001, 1, 264; Li, X. L. et al., Mater. Chem. Phys. 2003, 80, 222; and Liang, Z. H. et al., J. Phys. Chem. B. 2004, 108, 3488). α-Ni(OH)₂ nanostructures were synthesized by a sonochemical method (Mater. Chem. Phys. 2003, 80, 22). These studies imply the importance of controlling size and shape in NiO synthesis, however, these polycrystalline NiO samples usually consist of randomly oriented particles exposing several crystallographic faces. Preparations of NiO (111) have thus far been limited to prolonged cycles of metal nickel oxidation on a substrate in UHV at elevated temperature followed by high temperature annealing (Rohr, F. et al., Surf. Sci. 1994, 315, L977).

Benzyl alcohol has been found to be a successful medium to tailor metal oxides with well-controlled shape, size and crystallinity under anhydrous conditions, for example, TiO₂ nanoparticles of anatase phase in the 4-8 nm size range (Niederberger, M. et al. Chemistry of Materials 2002, 14, 4364-4370). Vanadium oxide nanorods and tungsten oxide nanoplatelets with identical morphology (Niederberger, M. et al., Journal of the American Chemical Society 2002, 124, 13642-13643) were synthesized in this medium by Stucky and co-workers from metal chloride precursors. Bimetallic oxides of Perovskite structured BaTiO₃, BaZrO₃, LiNbO₃ (Niederberger, M. et al. Angewandte Chemie—International Edition 2004, 43, 2270-2273) and SrTiO₃, (Ba, Sr)TiO₃ nanoparticles (Niederberger, M. et al., Journal of the American Chemical Society 2004, 126, 9120-9126) with controlled particle size and high crystallinity have also been prepared through a suggested C—C bond formation mechanism using metal alkoxides as the starting materials. In all of these studies, no selectivity in surface growth and no nanosheets with desired holes were found.

A general drawback of the above sot-gel processes employing benzyl alcohol for tailoring metal oxides with well-controlled shape, size and crystallinity, is the amorphous nature of the derived materials, and the following heat treatment to induce crystallization which usually leads to undesired particle morphology.

To explore new efficient template-free and practical methods for synthesis of nickel oxide nanosheets possessing the (111) crystallographic planes as a primary surface with hexagonal holes will open possibilities for new applications or improve existing performances.

### OBJECT OF THE INVENTION

It is therefore the object of the invention to provide with a novel template-free, halide-free wet chemical method to synthesize the novel NiO nanosheet structure with hexagonal holes possessing the (111) lattice plane as the main surface.

The additional object of the invention is providing an intermediate product of the synthesis, being a plate-like NiO nanosheet precursor, having the crystalline nature of the desired particle morphology before calcination.

The further object of the invention is to provide for a novel NiO nanosheet structure with hexagonal holes possessing the (111) lattice plane as the main surface.

Still another object of the invention is novel uses of the novel NiO nanosheet structure.

### SUMMARY OF THE INVENTION

According to the invention, the first object is met by a method for preparing a NiO nanosheet structure possessing (111) crystallographic planes as a primary surface with hexagonal holes, comprising the following steps: preparing a methanol solution of a nickel salt selected from the group consisting of nickel nitrate, nickel sulphate, nickel chlorate, nickel acetate, and nickel phosphate, or a mixture thereof; adding benzyl alcohol (BZ), optionally substituted with alkyl, nitro, halo or amino, or a mixture thereof and urea to the solution in a ratio of Ni to BZ or substituted BZ of at least 1; and solvent removal and calcination in air of the mixture.

In a preferred embodiment, the nickel salt is nickel nitrate.

Preferably, the ratio of Ni to BZ or substituted BZ is between 1:1 to 1:3.

In a specific embodiment, the solvent removal is accomplished by a supercritical treatment.

The invention is also directed to a intermediate product of the above synthesis, being a plate-like NiO nanosheet precursor, having the crystalline nature of the desired particle morphology before calcination. According to the invention, this plate-like NiO nanosheet precursor before calcination has the scanning electron microscope (SEM) images of FIG. 1, and the transmission electron microscope (TEM) images of FIG. 2.

The invention is also directed to NiO nanosheet structure possessing (111) crystallographic planes as a primary surface with hexagonal holes, in which the distance of the lattice planes in high resolution transmission electron microscopy (HRTEM) when imaging the nanosheets edge-on is 0.24-0.25 nm, and having the scanning electron microscope (SEM) images of FIGS. 3a and b, the transmission electron microscope (TEM) images of FIGS. 4 and 5, and the high resolution transmission electron microscopy (HRTEM) images of FIGS. 6a, 8c and 8d, and the powder X-ray diffraction (XRD) pattern of FIG. 7.

Preferably, the nanosheets have a thickness of less than 20 nm.

Advantageously, the edges of the hexagonal holes are substantially straight and parallel to each other, and/or the edge angles of the hexagonal holes are about 120°.

The NiO nanosheet structure preferably has the following electron diffraction data:

TABLE 1
The index planes of NiO nanosheets.

| D observed [Å] | D calculated [Å] | Indexing |
|---|---|---|
| 2.4049 | 2.4218 | 111 |
| 2.0826 | 2.0973 | 200 |
| 1.4742 | 1.4830 | 220 |
| 1.2584 | 1.2647 | 311 |
| 1.2051 | 1.2109 | 222 |

Finally, the invention is directed to novel uses of the inventive NiO nanosheet structure with hexagonal holes as a catalyst for methanol decomposition as formation at low temperature, more preferably, in fuel cells, electrochemical cells, and still more preferably in direct methanol fuel cells (DMFC), for example, for an electric vehicle propulsion, and optionally in alternative energy technologies, for example, for hydrogen generation or storage.

The invention is finally also directed to the use of the novel NiO nanosheet structure with hexagonal holes as a component or interconnect in nanodevices, as well as in electronic or magnetic devices.

Thus, a novel, one-pot approach for the synthesis of NiO nanosheets possessing the (111) crystallographic planes as a primary surface with hexagonal holes is provided using the inexpensive precursor nickel nitrate, optionally containing crystal water, as starting material. In the synthesis system, benzyl alcohol is used to control the synthesis of NiO (111) nanosheets. It is noted that NiO nanosheets with hexagonal holes possessing the (111) crystallographic planes as a primary surface are synthesized by the process of the present invention without using any templates or surfactants, thus avoiding subsequent complicated procedures of removing those substances.

Here, for the first time a template-free, halide-free efficient wet chemical method to synthesize NiO nanosheets with hexagonal holes possessing the (111) lattice plane as the main surface using nickel nitrate as starting materials is reported, and the synthesis process leads to excellent yields and high crystallinity of the products. The NiO (111) nanosheets are active for methanol decomposition at low temperature, which shows its potential application in, for example, fuel cells.

### BRIEF DESCRIPTION OF DRAWINGS

FIG. 1 illustrates SEM images of plate-like NiO precursor crystals before calcinations. The as-synthesized organic-inorganic crystals can be seen.

FIG. 2 illustrates TEM images of plate-like NiO precursor crystals before calcinations on porous carbon film.

FIGS. 3a and b illustrate SEM images of NiO nanosheets at two different magnifications.

FIG. 4 illustrates TEM images of NiO nanosheets with holes.

FIG. 5 illustrates TEM images of an isolated NiO nanosheet with holes. There are a lot of hexagonal holes in an isolated nanosheet and the edge angles are 120°.

FIG. 6 illustrates HRTEM image and FIG. 6 illustrates local FFT of the selected area in image of FIG. 6 of NiO nanosheets. The observed lattice spacings of 0.241 nm correspond to a set of (111) lattice planes forming the main surface of the NiO nanosheet crystal. The observed lattice spacings of 0.241 nm are in excellent agreement with literature known d-spacings for periclase (Rooksby H., Acta Crstallogr., 1948, 1, 226).

FIG. 7 illustrates the powder X-ray diffraction (XRD) patterns of (a) the as-synthesized or organic-inorganic crystals of the plate-like NiO nanosheets precursor and (b) the NiO nanosheets structure possessing the (111) crystallographic planes as a primary surface.

FIG. 8 illustrates (a) TEM image of the as-synthesized organic-inorganic crystals on porous carbon film; (b) TEM image of an isolated NiO (111) nanosheet with a lot of hexagonal holes; (c) HRTEM images and local FFT of NiO nanosheets, the observed lattice spacings of 0.241 nm correspond to a set of (111) lattice planes forming the main surface of the NiO nanosheet crystal and (d) HRTEM images and local FFT of NiO nanosheets, The observed lattice spacings of 0.241 nm correspond to two sets of (111) lattice planes forming the main surface of the NiO nanosheet crystal, the observed lattice spacings of 0.241 nm are in excellent agreement with literature known d-spacings (Rooksby, H. Acta Crstallogr., 1948, 1, 226).

FIG. 9 illustrates DRIFTS of methanol vapour at (a) 1 torr, (b) 0.1 torr and (c) 0.005 torr in equilibrium with NiO (111) nanosheets at room temperature.

FIG. 10 illustrates DRIFTS of methanol adsorption and reaction on NiO (111) nanosheets at different time (a) 5 min, (b) 10 min, (c) 15 min at 70° C.

FIG. 11 illustrates the mechanism of methanol oxidation and decomposition on the surface of NiO (111) nanosheets.

FIG. 12 illustrates DRIFTS of NiO (111) nanosheets treated under high vacuum at (a) room temperature, (b) 100° C., (c) 500° C.

FIG. 13 illustrates DRIFTS of the as-synthesized organic-inorganic crystals of the plate-like NiO nanosheets precursor at room temperature.

### DETAILED DESCRIPTION OF THE INVENTION

For the first time, the direct synthesis of NiO nanosheets with hexagonal holes by an efficient wet chemical synthetic approach, where the (111) facets form the main surfaces, has been accomplished. The NiO can maintain the sheet-like structure of the as-synthesized organic-inorganic crystals of the plate-like NiO nanosheet precursor before calcination due to the high crystallinity of the intermediate. The obtained NiO nanosheets with novel structure have potential application in nanodevices, can be used as a highly active solid catalysts and provide a prototype for the study of surface structure and surface reactions of polar oxide surfaces.

The NiO (111) nanosheets according to the invention have great commercial and technical potential. Nickel oxide is a promising material in several fields of applied technology such as in catalysis, high density magnetic data storage and the production of fuel cells. To synthesize nickel oxide with this novel structure will find its optional applications or improve existing performances. The starting materials are cheap, the synthetic process is simple, low-cost and practical, it is easy to scale up.

The NiO (111) nanosheets according to the invention material can be readily identified through a combination of the X-ray diffraction (XRD) pattern and the transmission electron microscope (TEM) image.

### EXAMPLE

In a preferred embodiment of the invention, in the synthesis of the NiO nanosheets structure, 9 g of Ni(NO₃)₂.6H₂O was dissolved in 100 ml absolute methanol. After the Ni(NO₃)₂.6H₂O totally dissolved, 1 g urea and benzyl alcohol was added to the mixture in the ratio Ni:BZ=2 (molar ratio). After stirring for 1 h, the mixture solution was transferred to an autoclave. The autoclave containing the reaction mixture was purged with 10 bar (7500 torr) Ar 5 times, and then a pressure of 10 bar (7500 torr) Ar was imposed before heating starts. The mixture was heated to 200° C. for 5 h, then heated to 265° C. and maintained at that temperature for 1.5 h, at last, the vapour inside was vented (thereby removing the solvent in the supercritical state). A dry jade-green powder was collected and subsequently calcined with a ramp rate of PC/min to 500° C., then maintained at 500° C. for 6 h. The powder produced from this preparation contains solely the NiO nanosheets possessing the (111) crystallographic planes with hexagonal holes (edge angles of 120°).

The materials were characterized by powder X-ray diffraction (XRD) using a Siemens D5000 X-ray diffractometer with nickel filtered Cu Kα radiation (λ=1.5418 Å) at a scanning rate of 0.1°·min⁻¹ in the 2θ range of 5-80°.

Transmission electron microscopic (TEM) characterization of the as-synthesized organic-inorganic hybrid materials of the plate-like NiO nanosheet precursor before calcination and NiO samples was carried out on a JEM-2010 operated at 200 kV. The samples were prepared by spreading an ultrasonicated suspension in ethanol.

In-situ DRIFTS investigation: A Thermo 4700 IR spectrometer with liquid nitrogen cooled detector, a high temperature chamber and DRIFT accessory were used with the following parameters: 64 scans, 600-4000 cm⁻¹ scan range, 4 cm⁻¹ resolution.

In-situ DRIFTS investigation of NiO (111) nanosheets: The sample temperature was measured through a thermocouple inserted into the sample holder directly in contact with the sample. A spectrum of the KBr was collected at room temperature under high vacuum and was used as the background. 10 mg of sample was placed into a high temperature sample holder; the chamber was evacuated and pressure remained 0.005 torr. The spectra were collected under high vacuum at room temperature. Following this scan, the temperature was raised to 100° C., and another scan was taken. After this scan, the temperature was raised to 500° C. and maintained for 1 h, finally, the last spectra was collected.

In-situ DRIFTS investigation of methanol adsorption and surface reaction: 10 mg sample was pretreated at 500° C. for 1 h under high vacuum to remove any water or other impurities from its surface. A spectrum of the clean sample surface was collected following this procedure at the adsorption temperature (room temperature or 70° C.) under high vacuum and was used as the background. Methanol vapour was obtained by evapouration under high vacuum. The high vacuum reactor, directly connected to the DRIFT chamber, allows us to work in flow conditions. Methanol was introduced into the reaction chamber at 0.005 torr while the NiO sample was maintained at the adsorption temperature (room temperature or 70° C.). For in-situ DRIFT spectra at room temperature, when the reaction chamber was evacuated to 1, 0.1 and 0.005 torr, respectively, the vacuum valve was closed and the spectra was collected after 2 minutes of equilibrium. For the experiments at 70° C., after introduction of methanol and equilibrium for 3 minutes, the methanol introduction valve was closed; and the spectra were collected every several minutes.

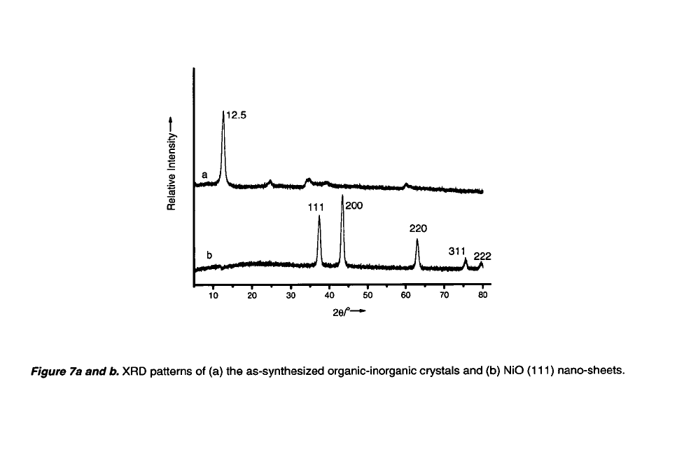

The powder X-ray diffraction (XRD) pattern of the NiO nanosheets is shown in FIG. 7a. The intensity of the peak at 2θ=12.5° is very strong, indicating the as-synthesized product is highly crystalline. After calcination at 500° C., the grey powder product is a single phase of well crystallized NiO with the Fm-3m structure (Rooksby, H. Acta Crstallogr., 1948, 1, 226). The XRD pattern of the grey powder (FIG. 7b) shows peaks of (111), (200), (220), (311) and (222) corresponding to the d-spacing 2.4049, 2.0826, 1.4742, 1.2584 and 1.2051 Å, respectively, that match well with the JCPDF 65-2901 card. These peaks are relatively broad, corresponding to a particle size of 14.9 nm according to the Debye-Scherrer equation.

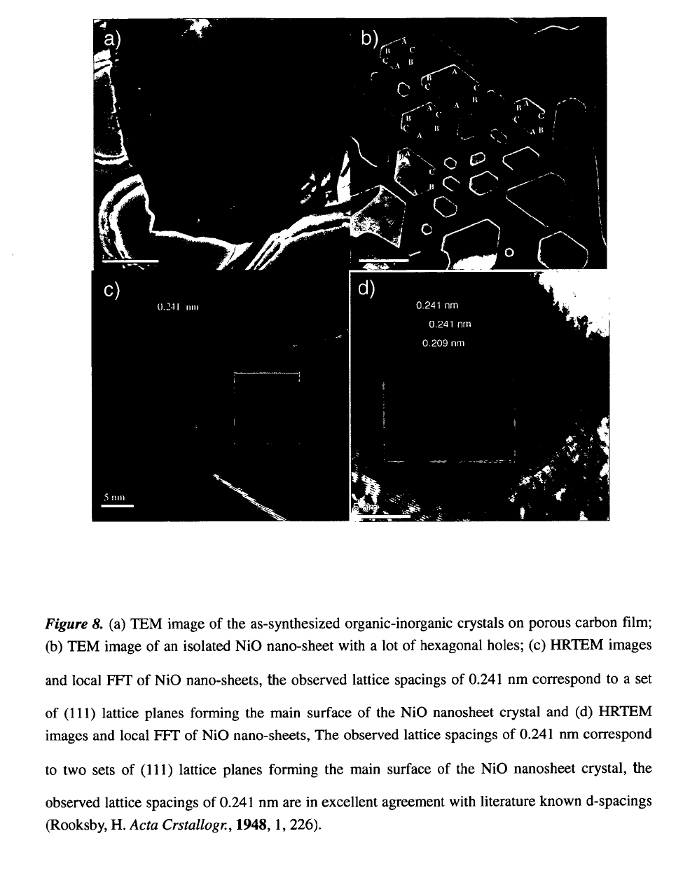

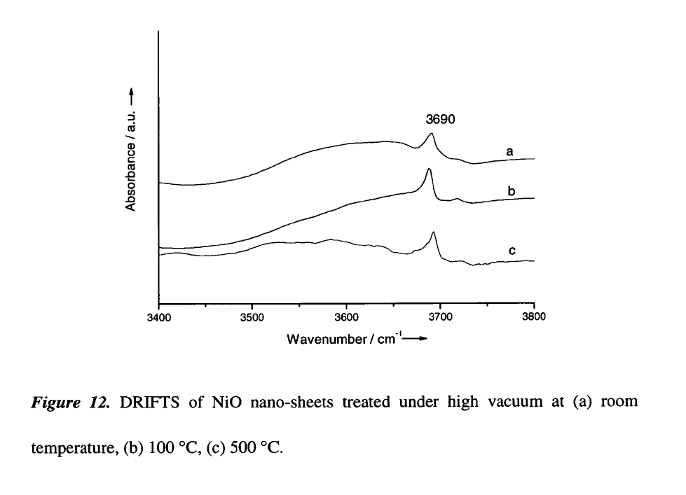

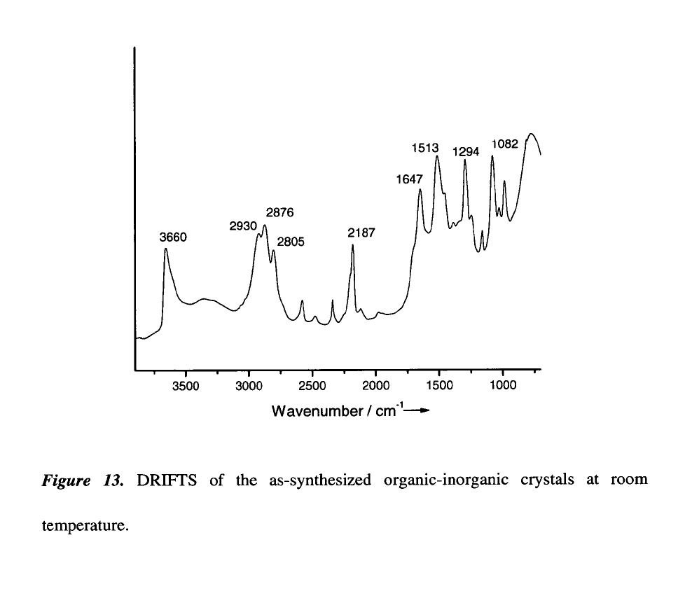

Transmission electron microscope (TEM) images reveal the morphology differences of the as-synthesized product and NiO. The as-synthesised product shows a sheet-like structure (FIG. 8a). DRIFT spectroscopy results prove the presence of organic species in the highly crystalline sheet-like structure (FIGS. 12 and 13). The bands at 1082, 2805, 2876 and 2930 cm⁻¹ are indicative of the presence of methoxyl groups. The bands at 3660 and 1647 cm⁻¹ corresponding to stretching and bending vibrations of OH respectively indicate the presence of hydroxyl group. The bands at 1513, 1294 and 2187 cm⁻¹ indicate the surface carbonate species which may result from the hydrolysis of urea (Diao, Y., et al., Chem. Mater. 2002, 14, 362). There is no indication of the skeletal vibration of aromatic rings, indicating that the benzyl alcohol has been removed during the supercritical drying process. The DRIFTS and XRD results suggest that the as-synthesized product is a highly crystalline material containing hydroxyl groups, methoxyl groups and CO₃²⁻. In the synthesis system, benzyl alcohol and the NH₄OH from the slow hydrolysis of urea adjust the hydrolysis and gelation rate of nickel nitrate, and help form the sheet-like organic-inorganic hybrid structure. After calcination, the NiO maintained the sheet-like structure with a typical thickness of 3-10 nm which may due to the high crystallinity of the as-synthesized organic-inorganic compound and there are a number of hexagonal holes formed in the nanosheets (FIG. 8b). The edges of these hexagonal holes (AB) are straight and parallel to each other. The BC and AC edges are also straight and parallel to each other. Moreover, the angles between two straight lines from three AB, BC and AC directions are oriented at 120°.

NiO is a p-type semiconductor; the novel structure should have potential applications as components and interconnects in nano devices. HRTEM analysis of the NiO nanosheets shows that the main surface of the nanosheets are parallel to the (111) lattice planes. The NiO (111) facet is composed of alternating layers of oxygen and nickel atoms and thus, the surface of NiO (111) has a strong electropolarity. When operating by directing the incident electron beam perpendicular to the facet of the nanosheet, the HRTEM images exhibit lattice fringes with a distance of 0.24-0.25 nm parallel to the main surface of the nanosheet in good agreement with the {111} lattice spacing in NiO (FIGS. 8c and d). Theoretical studies suggest that the (111) surface is stabilized by hydroxyl groups (Langell, M. A., et al. J. Phys. Chem. 1995, 99, 4162). The stretching frequencies of hydroxyl groups decrease with the coordination number from 3735 cm⁻¹ (1-coordination) to 3630 cm⁻¹ (penta-coordination). In our case, the peak at 3690 cm⁻¹ should be attributed to tri-coordinated hydroxyl groups corresponding to the (111) structure where one surface oxygen anion coordinates with three Ni²⁺ (FIG. 12). The hydroxyl groups are stable at 500° C., in view of the inherent instability of polar surfaces, the observed OH groups on NiO (111) may be rationalized to be due to a stabilization of the (111) surface by hydroxyl groups.

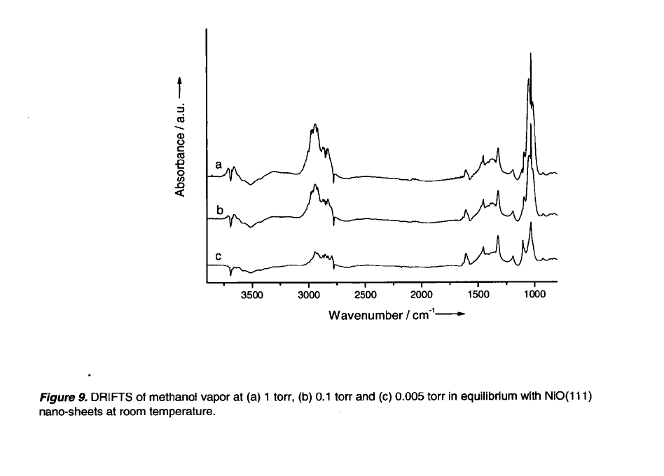

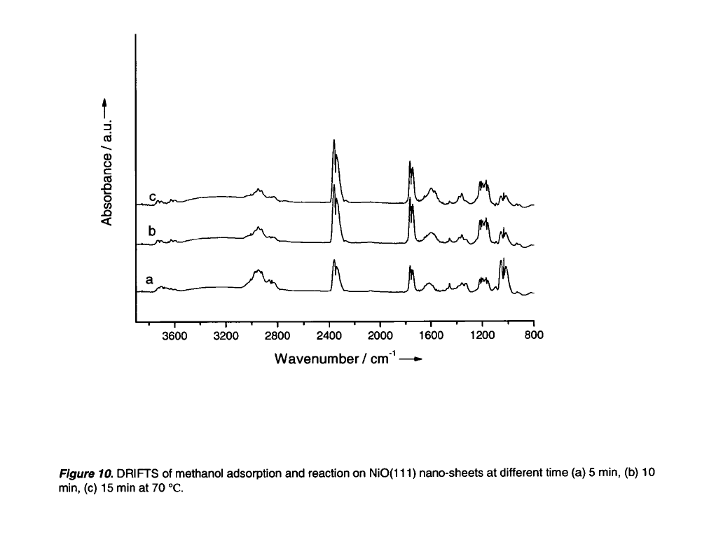

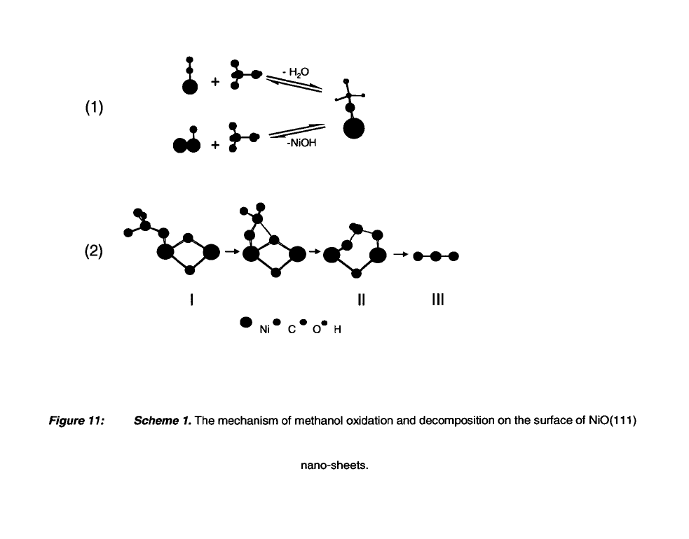

Methanol is a “smart” molecular probe that can provide fundamental information about the number and the nature of surface active sites (Badlani, M., et al., Catal. Lett. 2001, 73, 3-4, 137). The decomposition of methanol provides both fundamental knowledge about the surface and is also interesting for potential applications in direct methanol fuel cells. In order to increase our understanding about the surface structure, properties and potential applications of the NiO (111) nanosheets, in the present work, we have characterized the NiO (111) nanosheets systematically and investigated methanol adsorption and reaction on the surface of NiO (111) nanosheets at low temperature. DRIFT spectra of NiO (111) nanosheets exposed to methanol vapour pressures of 1, 0.1 and 0.005 torr at room temperature were collected. The presence of gas-phase and weakly adsorbed methanol in the DRIFT spectra obtained after exposure of the NiO (111) nanosheets to methanol at room temperature, is suggested by the characteristic adsorptions in the spectral region of C—O stretching (FIG. 9a, 1050, 1034, and 1015 cm⁻) and is confirmed by the broad and intense O—H bands (between 3500 and 3200 cm⁻) and C—H bands (between 2700 and 3200 cm⁻¹) stretching contributions. The negative peak at 3690 cm⁻¹ suggests that surface hydroxyl groups react with methanol by forming a hydrogen bond or forming water by methanol dissociative chemisorption. It is noteworthy that an intense peak at 1606 associated with a pair of bands at 1452 and 1320 is observed, which is assigned to the OCO asymmetric and symmetric stretching modes of an intermediate formate species adsorbed on the NiO (111) nanosheets surface. These results indicate that methanol can be oxidized on the surface of NiO (111) nanosheets at room temperature. Both undissociated and dissociated methanol have been observed when NiO (111) nanosheets are exposed to methanol at 70° C. (FIG. 10). A large amount of CO₂ formed upon exposure to methanol at 70° C. (peaks at 2360 and 2341 cm⁻¹) and increased with time. A weak, pair of peaks at 1764 and 1743 cm⁻¹, can be attributed to the C═O asymmetric stretching of CO and formic acid (Millikan, R. C., et al., J. Am. Chem. Soc. 1958, 80, 3515; Kustov, L. M., et al., Catal. Lett. 1991, 9, 121). The bands of CO₂ at 2360 and 2341 cm⁻¹ increase and the bands of C—H stretching between 2800 and 3100 cm⁻¹ decrease in intensity with the time, indicating that the methanol decomposition continues with time. This suggests that NiO (111) nanosheets are active for methanol decomposition. In comparison with the spectra at room temperature, the region of O—H stretching has no distinct change; indicating that methanol interacts primarily with surface oxygen anions and oxygen defects at 70° C. This implies that the main active sites for methanol decomposition are oxygen defects and oxygen anions. The detailed methanol adsorption and decomposition mechanism is shown in Scheme 1 (FIG. 11). Methanol reacts with the hydroxyl groups and oxygen defects on the surface of NiO (111) nanosheets to form methoxyl groups (I), then, the methoxy groups interact with the surface oxygen anions to lose hydrogen and mutate to formate species (II), finally, formate species decomposition and dehydrogenation produce CO₂ (III). This result is relevant for applications in fuel cells and other alternative energy technologies. Methanol is also an excellent fuel in its own right and it can also be blended with gasoline, although it has half the volumetric energy density relative to gasoline or diesel (Olah, G. A., Angew. Chem. Int. Ed. 2005, 44, 2636; Angew. Chem. 2005, 117, 2692). It is also used in the direct methanol fuel cell (DMFC). Performance of the liquid feed methanol fuel cells is already attractive for some applications and is approaching the levels required for electric vehicle propulsion (Kustov, L. M. et al., Catal. Lett. 1991, 9, 121). In these electrochemical cells, methanol is directly oxidized with air to carbon dioxide and water to produce electricity, without the need to first generate hydrogen (Surumpudi, S. et al., J. Power Sources 1994, 47, 217; Prakash, G. K. S. et al., J. Fluorine Chem. 2004, 125, 1217). This greatly simplifies the fuel cell technology and makes it available to a broad range of applications. The conventional Cu/ZnO-based methanol synthesis catalysts performed poorly in the methanol decomposition (Cheng, W., Acc. Chem. Res. 1999, 32, 685). The catalysts suffered from rapid deactivation. The activity and stability of the catalysts have been two major challenges associated with methanol decomposition. The NiO (111) nanosheets can decompose methanol at low temperature and their preparation is simple and has scale-up potential. The large-scale application of NiO (111) nanosheets catalysts without transition metals for low temperature methanol decomposition or formation may be feasible.

The features disclosed in the foregoing description, drawings and claims may, both separately and in any combination thereof, be material for realizing the invention in diverse forms thereof.

### Example 1

In a preferred embodiment of the invention, in the synthesis of the NiO nanosheets structure, 9 g of Ni(NO₃)₂.6H₂O was dissolved in 100 ml absolute methanol. After the Ni(NO₃)₂.6H₂O totally dissolved, 1 g urea and 6.7 g benzyl alcohol was added to the mixture in the ratio Ni:urea:BZ=1:0.5:2 (molar ratio). After stirring for 1 h, the mixture solution was transferred to an autoclave. The autoclave containing the reaction mixture was purged with 10 bar (7500 torr) Ar 5 times, and then a pressure of 10 bar (7500 torr) Ar was imposed before heating starts. The mixture was heated to 200° C. for 5 h, then heated to 265° C. and maintained at that temperature for 1.5 h, at last, the vapour inside was vented (thereby removing the solvent in the supercritical state). A dry jade-green powder was collected and subsequently calcined with a ramp rate of 3° C./min to 500° C., then maintained at 500° C. for 6 h. The powder produced from this preparation contains solely the NiO nanosheets possessing the (111) crystallographic planes with hexagonal holes (edge angles of 120°). The typical diameter of these nano-sheets is about 1 μm, and the typical size of holes is 20-100 nm.

### Example 2

9 g of Ni(NO₃)₂.6H₂O was dissolved in 100 ml absolute methanol. After the Ni(NO₃)₂.6H₂O dissolved completely, 6.7 g benzyl alcohol was added to the mixture in the ratio Ni:benzyl alcohol=1:2 (molar ratio). After stirring for 1 h, the solution was transferred to an autoclave and the reaction mixture was purged with 7500 torr Ar 5 times, and then a pressure of 7500 torr Ar was imposed before initiating heating. The mixture was heated to 200° C. for 5 h, then to 265° C. and maintained at that temperature for 1.5 h; finally, the vapor inside was vented. After the supercritical fluid drying (SCFD), a green powder was collected and subsequently calcined in air with a ramp rate of 3° C./min to 500° C., then maintained at 500° C. for 6 h. The powder produced from this preparation contains solely the NiO nanosheets possessing the (111) crystallographic planes with hexagonal holes (edge angles of 120°). The typical diameter of these nano-sheets is about 3 μm, and the typical size of holes is 20-100 nm.

### Example 3

9 g of Ni(NO₃)₂.6H₂O was dissolved in 100 ml absolute methanol. After the Ni(NO₃)₂.6H₂O totally dissolved, 2 g urea and benzyl alcohol was added to the mixture in the ratio Ni:urea:BZ=1:1:2 (molar ratio). After stirring for 1 h, the mixture solution was transferred to an autoclave. The autoclave containing the reaction mixture was purged with 10 bar (7500 torr) Ar 5 times, and then a pressure of 10 bar (7500 torr) Ar was imposed before heating starts. The mixture was heated to 200° C. for 5 h, then heated to 265° C. and maintained at that temperature for 1.5 h, at last, the vapour inside was vented. A dry jade-green powder was collected and subsequently calcined with a ramp rate of 3° C./min to 500° C., then maintained at 500° C. for 6 h. The powder produced from this preparation contains solely the NiO nanosheets possessing the (111) crystallographic planes with hexagonal holes (edge angles of 120°). The typical diameter of these nano-sheets is about 0.3 μm, and the typical size of holes is 20-100 nm.

### Example 4

9 g of Ni(NO₃)₂.6H₂O was dissolved in 100 ml absolute methanol. After the Ni(NO₃)₂.6H₂O dissolved completely, 6.7 g benzyl alcohol was added to the mixture in the ratio Ni:benzyl alcohol=1:2 (molar ratio). After stirring for 1 h, the solution was transferred to an autoclave and the reaction mixture was purged with 7500 torr Ar 5 times, and then a pressure of 7500 torr Ar was imposed before initiating heating. The mixture was heated to 200° C. for 5 h, then to 265° C. and maintained at that temperature for 1.5 h; finally, the vapor inside was vented. After the supercritical fluid drying (SCFD), a green powder was collected and subsequently calcined in oxygen with a ramp rate of 3° C./min to 500° C., then maintained at 500° C. for 6 h. The powder produced from this preparation contains solely the NiO nanosheets possessing the (111) crystallographic planes with hexagonal holes (edge angles of 120°). The typical diameter of these nano-sheets is about 1 μm, and the typical size of holes is 20-100 nm.

### Example 5

9 g of Ni(NO₃)₂.6H₂O was dissolved in 100 ml absolute methanol. After the Ni(NO₃)₂.6H₂O dissolved completely, 6.7 g benzyl alcohol was added to the mixture in the ratio Ni:benzyl alcohol=1:2 (molar ratio). After stirring for 1 h, the solution was transferred to an autoclave and the reaction mixture was purged with 7500 torr Ar 5 times, and then a pressure of 7500 ton Ar was imposed before initiating heating. The mixture was heated to 200° C. for 5 h, then to 265° C. and maintained at that temperature for 1.5 h; finally, the vapor inside was vented. After the supercritical fluid drying (SCFD), a green powder was collected and subsequently calcined in nitrogen with a ramp rate of 3° C./min to 500° C., then maintained at 500° C. for 6 h. The powder produced from this preparation contains solely the NiO nanosheets possessing the (111) crystallographic planes with hexagonal holes (edge angles of 120°). The typical diameter of these nano-sheets is about 3 μm, and the typical size of holes is 20-100 nm.

### Example 6

9 g of Ni(NO₃)₂.6H₂O was dissolved in 100 ml absolute methanol. After the Ni(NO₃)₂.6H₂O dissolved completely, 6.7 g benzyl alcohol was added to the mixture in the ratio Ni:benzyl alcohol=1:2 (molar ratio). After stirring for 1 h, the solution was transferred to an autoclave and the reaction mixture was purged with 7500 torr Ar 5 times, and then a pressure of 7500 torr Ar was imposed before initiating heating. The mixture was heated to 200° C. for 5 h, then to 265° C. and maintained at that temperature for 1.5 h; finally, the vapor inside was vented. After the supercritical fluid drying (SCFD), a green powder was collected and subsequently calcined in air with a ramp rate of 3° C./min to 350° C., then maintained at 350° C. for 0.5 h. The typical diameter of these nano-sheets is about 3 μm, and the typical size of holes is less than 10 nm.

1. Method for preparing a NiO nanosheet structure possessing (111) crystallographic planes as a primary surface with hexagonal holes,
comprising the following steps:
a) preparing a methanol solution of a nickel salt selected from the group consisting of nickel nitrate, nickel sulphate, nickel chlorate, nickel acetate, and nickel phosphate or a mixture thereof;
b) adding benzyl alcohol (BZ), optionally substituted with alkyl, nitro, halo or amino, or a mixture thereof and urea to the solution of (a) in a ratio of Ni to BZ or substituted BZ of at least 1;
c) solvent removal and calcination in air of the mixture.

2. Method according to claim 1, wherein the nickel salt is nickel nitrate.

3. Method according to claim 1, wherein the ratio of Ni to BZ is between 1:1 to 1:3.

4. Method according to claim 1, wherein the solvent removal is accomplished by a supercritical treatment.

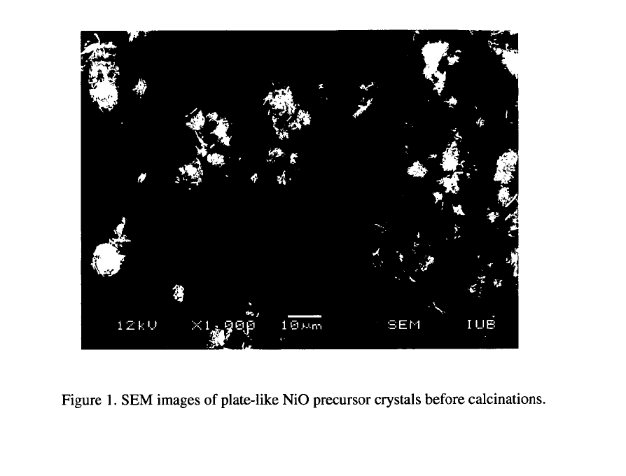

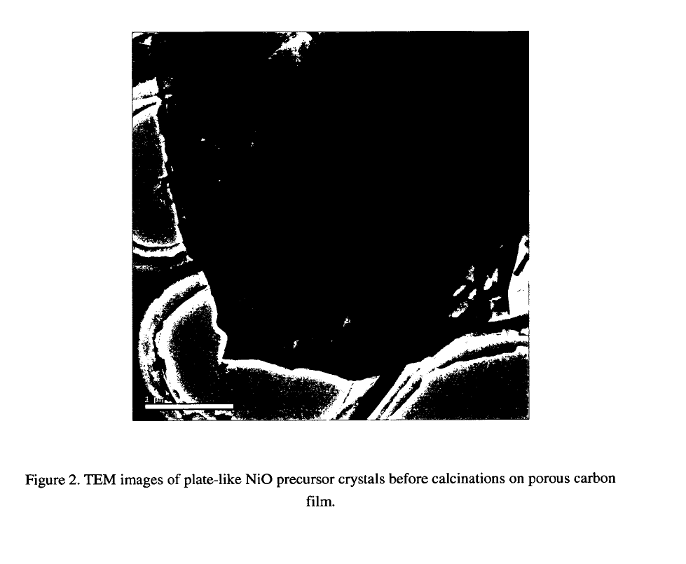

5. Plate-like NiO nanosheet precursor having the scanning electron microscope (SEM) images of FIG. 1, and the transmission electron microscope (TEM) images of FIG. 2.

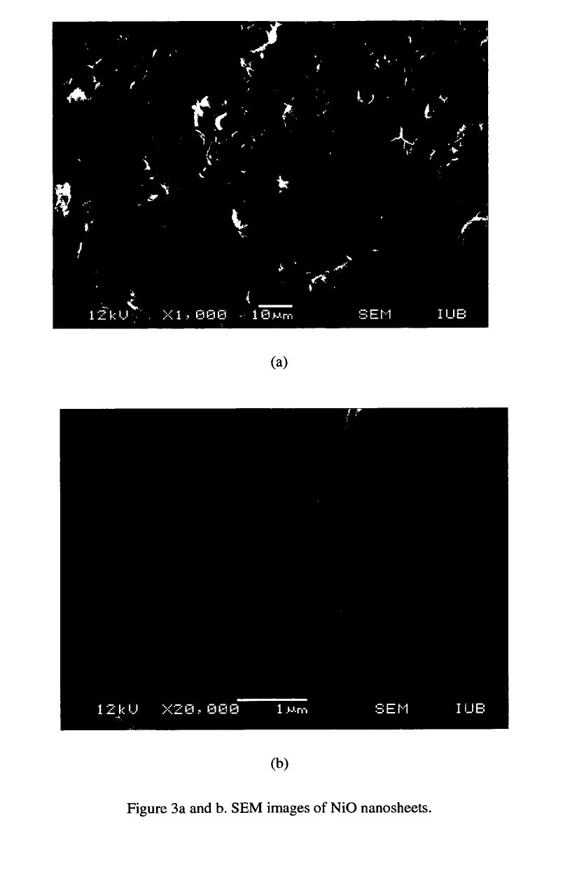

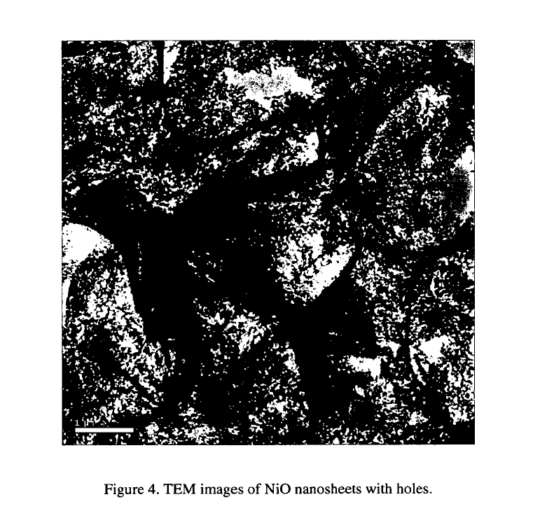

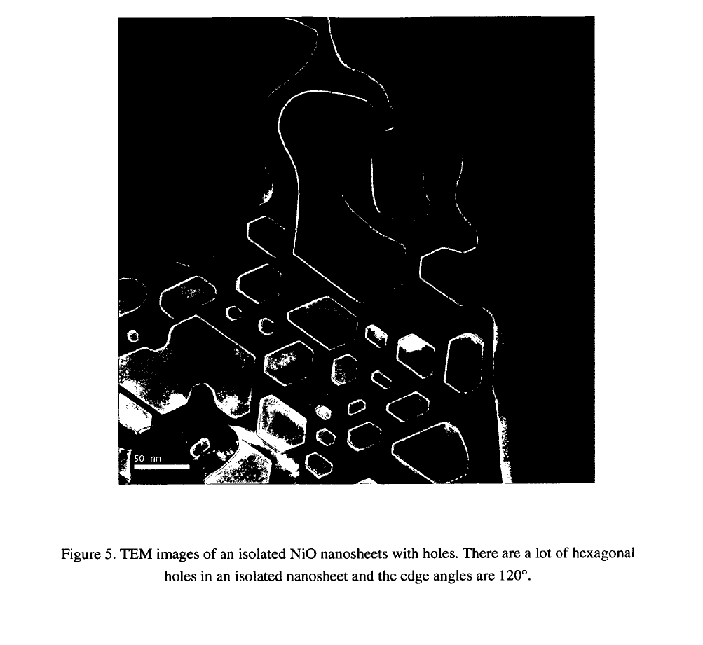

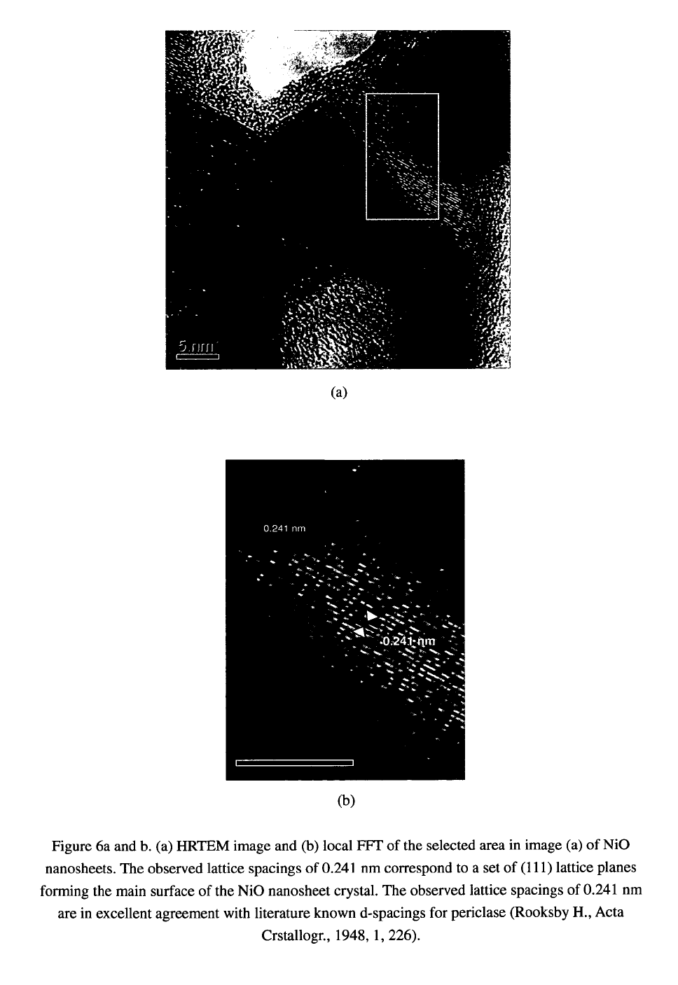

6. NiO nanosheet structure possessing (111) crystallographic planes as a primary surface with hexagonal holes, in which the distance of the lattice planes in high resolution transmission electron microscopy (HRTEM) when imaging the nanosheets edge-on is 0.24-0.25 nm, and having the scanning electron microscope (SEM) images of FIGS. 3a and b, the transmission electron microscope (TEM) images of FIGS. 4 and 5, and the high resolution transmission electron microscopy (HRTEM) images of FIGS. 6a, 8c and 8d, as well as the powder X-ray diffraction (XRD) pattern of FIG. 7.

7. NiO nanosheet structure according to claim 5, wherein the nanosheets have a thickness of less than 20 nm.

8. NiO nanosheet structure according to claim 5, wherein the edges of the hexagonal holes are substantially straight and parallel to each other.

9. NiO nanosheet structure according to claim 5, wherein the edge angles of the hexagonal holes are about 120°.

10. NiO nanosheet structure according to claim 5, having the following electron diffraction data:

| D observed [Å] | D calculated [Å] | Indexing |
|---|---|---|
| 2.4049 | 2.4218 | 111 |
| 2.0826 | 2.0973 | 200 |
| 1.4742 | 1.4830 | 220 |
| 1.2584 | 1.2647 | 311 |
| 1.2051 | 1.2109 | 222 |

11. Use of the NiO nanosheet structure with hexagonal holes as claimed in claim 5 as a catalyst for low temperature methanol decomposition or formation.

12. Use according to claim 10 in fuel cells.

13. Use according to claim 10 in electrochemical cells.

14. Use according to claim 10 in direct methanol fuel cells (DMFC).

15. Use according to claim 10 for electric vehicle propulsion.

16. Use according to claim 10 in alternative energy technologies.

17. Use according to claim 15 for hydrogen generation or storage.

18. Use of the NiO nanosheet structure with hexagonal holes as claimed in claim 5 as a component or interconnect in nanodevices.

19. Use of the NiO nanosheet structure with hexagonal holes as claimed in claim 5 in electronic or magnetic devices.
